(19) United States
(12) Patent Application Publication
(10) Pub. No.: US 2018/0145502 A1
(43) Pub. Date: May 24, 2018

(54) INTELLIGENTIALIZE MOTIVE POWER MODULE, DRIVING CONTROL APPARATUS FOR MOTOR, AND DRIVING CONTROL METHOD THEREOF

(71) Applicant: Metal Industries Research & Development Centre, Kaohsiung (TW)

(72) Inventors: Chang-Ching Lin, Kaohsiung City (TW); Cheng-Yen Chen, Kaohsiung City (TW)

(73) Assignee: Metal Industries Research & Development Centre, Kaohsiung (TW)

(21) Appl. No.: 15/359,552

(22) Filed: Nov. 22, 2016

(51) Int. Cl. H02H 7/08; H02P 27/08; B60L 3/00

(52) U.S. Cl. CPC H02H 7/0805; H02P 27/08; B60L 2200/12; B60L 3/0061; H02H 7/0833

(57) ABSTRACT

An intelligentialize motive power module, a driving control apparatus for a motor, and a driving control method thereof are provided. The driving control apparatus includes a driver, a voltage detector, and a control processor. The driver generates a plurality of control voltages according to an electric assisted command, and provides a plurality of power transistors for driving the motor according to the control voltages. The voltage detector receives a plurality of phase voltages. The control processor is used to: calculate a direct-current value, a cosine signal and a sine signal corresponding to each of the phase voltages; calculate a phase amplitude according to the cosine signal and the sine signal corresponding to each of the phase voltages; and, generate a phase abnormal detection result according to the phase amplitude corresponding to each of the phase voltages.

### BACKGROUND OF THE INVENTION

### Field of the Invention

The invention relates to an intelligentialize motive power module, a driving control apparatus for motor and a driving control method thereof, and particularly relates to an intelligentialize motive power module, a driving control apparatus for motor and a driving control method thereof capable of detecting a phase abnormal phenomenon.

### Description of Related Art

In a technical field of intelligentialize motive power module, a user is required to tread on a pedal of a bicycle in order to activate a power motor to control a power output. Due to restrictions of related regulations, when a speed of the bicycle reaches a limited standard (for example, 25 km/h), the power output of the motor is required to be stopped, and when the user stops treading the pedal of the bicycle, the power output of the motor is also stopped.

Since in the process of travelling on the road, the bicycle may encounter different situations, the aforementioned limitation of the motor power output is probably not enough to provide a safety guarantee to the user, and not enough to prevent the motor of the bicycle from being damaged. Therefore, it is an important issue for related technicians of the field to provide more determination methods for the motor power control.

### SUMMARY OF THE INVENTION

The invention is directed to an intelligentialize motive power module, a driving control apparatus for motor and a driving control method thereof, which are adapted to effectively stop motor running at a proper moment, so as to prevent motor damage and guarantee user safety.

The invention provides a driving control apparatus for motor, which includes a driver, a voltage detector, and a control processor. The driver generates a plurality of control voltages according to an electric assisted command, and provides a plurality of power transistors for driving the motor according to the control voltages. The voltage detector is coupled to the power transistors and receives a plurality of phase voltages provided to the motor by the power transistors. The control processor is coupled to the voltage detector, and is configured to: calculate a direct-current value, a cosine signal and a sine signal corresponding to each of the phase voltages; calculate a phase amplitude corresponding to each of the phase voltages according to the cosine signal and the sine signal corresponding to each of the phase voltages; and generate a phase abnormal detection result corresponding to each of the phase voltages according to the phase amplitude corresponding to each of the phase voltages.

In an embodiment of the invention, the control processor calculates a maximum amplitude value of the cosine signal and a maximum amplitude value of the sine signal corresponding to each of the phase voltages, and calculates the phase amplitude corresponding to each of the phase voltages according to the maximum amplitude value of the cosine signal and the maximum amplitude value of the sine signal corresponding to each of the phase voltages.

In an embodiment of the invention, the control processor compares the phase amplitude corresponding to each of the phase voltages and a threshold, so as to determine whether each of the phase voltages is abnormal.

In an embodiment of the invention, the control processor transmits an interrupt command to the driver when the phase amplitude of one of the phase voltages is greater than the threshold, where the driver makes the motor to stop running according to the interrupt command.

In an embodiment of the invention, the control processor further calculates a phase angle corresponding to each of the phase voltages according to the cosine signal and the sine signal corresponding to each of the phase voltages.

In an embodiment of the invention, the control processor further determines at least one abnormal phase voltage of the phase voltages with abnormal phase angles, and calculates at least one malfunctioned power transistor in the power transistors according to the phase angle of the abnormal phase voltage.

In an embodiment of the invention, the driving control apparatus further includes a portable electronic device, which is wirelessly coupled to the control processor, and receives the phase abnormal detection results, and generates a warning signal.

In an embodiment of the invention, the portable electronic device includes a wireless transmission interface, a signal processor and a user warning interface. The wireless transmission interface is wirelessly coupled to the control processor, and receives the phase abnormal detection results. The signal processor is coupled to the wireless transmission interface, and receives and processes the phase abnormal detection results to generate processing information. The user warning interface is coupled to the signal processor, and generates the warning signal according to the processing information.

In an embodiment of the invention, the driving control apparatus further includes a filter. The filter is coupled between the voltage detector and the control processor, and filters the phase voltages.

The invention provides an intelligentialize motive power module including a motor and the aforementioned driving control apparatus. The driving control apparatus is coupled to the motor, and drives the motor to run.

The invention provides a driving control method for motor, which includes following steps: generating a plurality of control voltages according to an electric assisted command, and providing a plurality of power transistors for driving the motor according to the control voltages; calculating a direct-current value, a cosine signal and a sine signal corresponding to each of the phase voltages according to frequency domain analysis; calculating a phase amplitude corresponding to each of the phase voltages according to the cosine signal and the sine signal corresponding to each of the phase voltages; and generating a phase abnormal detection result corresponding to each of the phase voltages according to the phase amplitude corresponding to each of the phase voltages.

According to the above description, the phase amplitude of each of the phase voltages of the motor is calculated, and it is determined whether the motor has a phase voltage abnormal phenomenon according to the phase amplitude of each of the phase voltages. Moreover, when the motor has the phase voltage abnormal phenomenon, the motor is stopped running to prevent the motor from damage, so as to effectively protect user's safety.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a driving control apparatus for motor according to an embodiment of the invention.

FIG. 2 is a flowchart illustrating a driving control method according to an embodiment of the invention.

FIG. 3 is a flowchart illustrating a driving control method for motor according to an embodiment of the invention.

FIG. 4 is a schematic diagram of a driving control apparatus for motor according to another embodiment of the invention.

FIG. 5 is a partial block diagram of a driving control apparatus according to an embodiment of the invention.

FIG. 6 is a schematic diagram of an intelligentialize motive power module according to an embodiment of the invention.

### DESCRIPTION OF EMBODIMENTS

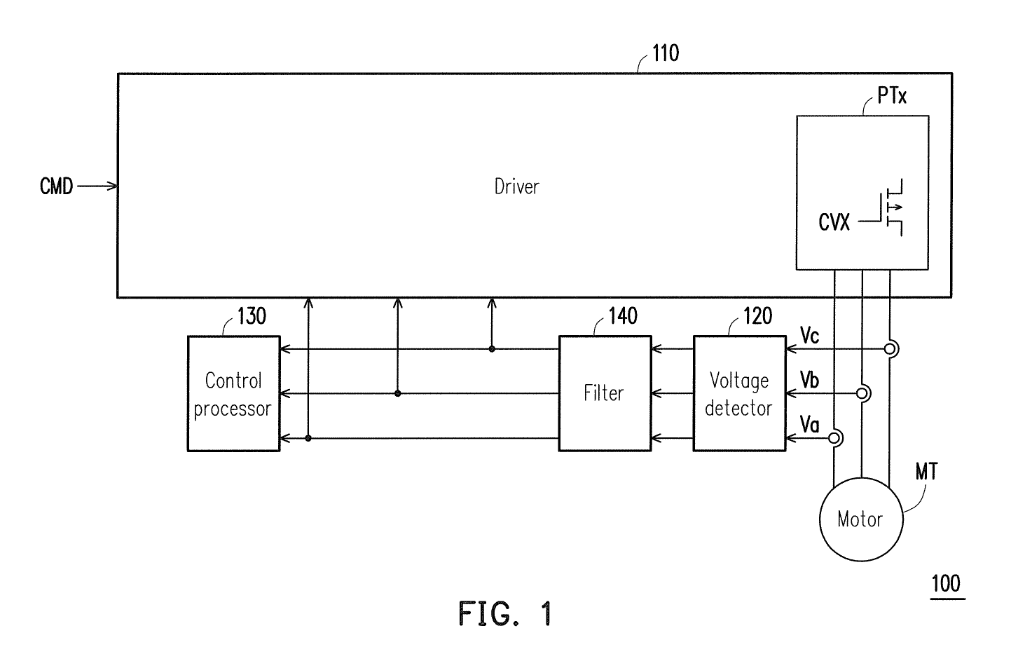

Referring to FIG. 1, FIG. 1 is a schematic diagram of a driving control apparatus for motor according to an embodiment of the invention. The driving control apparatus 100 is used for driving a motor MT, the driving control apparatus 100 includes a driver 110, a voltage detector 120, a control processor 130 and a filter 140. The driver 110 generates a plurality of control voltages CVx according to an electric assisted command CMD, and provides a plurality of power transistors PTx for driving the motor MT according to the control voltages CVx. The power transistors PTx generate a plurality of phase voltages Va, Vb and Vc according to the control voltages CVx. The phase voltages Va, Vb and Vc are provided to the motor MT to drive the motor MT to rotate. The motor MT can be a brushless motor.

In the present embodiment, the voltage detector 120 is coupled to the driver 110, and is used for detecting the phase voltages Va, Vb and Vc provided by the power transistors PTx. In order to improve the signal quality, the phase voltages Va, Vb and Vc detected by the voltage detector 120 can be transmitted to the filter 140, and the filter 140 filters unnecessary noises on the phase voltages Va, Vb and Vc.

The control processor 130 is coupled to the filter 140, and receives the filtered phase voltages Va, Vb and Vc. The control processor 130 executes signal analysis operations to the phase voltages Va, Vb and Vc to detect whether there is a phase abnormal phenomenon.

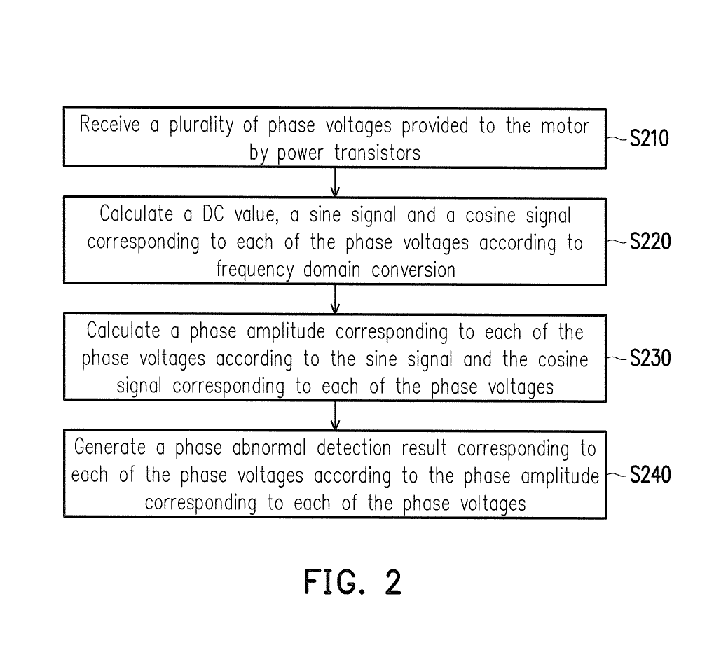

Referring to FIG. 2 for a flow for determining phase abnormity of the embodiment of the invention, and FIG. 2 is a flowchart illustrating a driving control method according to an embodiment of the invention. In step S210, the control processor 130 receives the phase voltages Va, Vb and Vc provided by the power transistors PTx, and in step S220, the control processor 130 performs a frequency domain analysis (for example, Fourier analysis) to the values of the phase voltages Va, Vb and Vc, and decomposes each of the phase voltages Va, Vb and Vc to generate a direct-current (DC) value, a sine signal and a cosine signal corresponding to each of the phase voltages.

Taking the phase voltage Va as an example, the control processor 130 may perform Fourier transform to the phase voltage Va, and the phase voltage Va is represented by a following equation (1):

$$Va ( t ) = {a}_{0} + {\sum }_{n = 1}^{∞} ( {a}_{n} cos ( n ϖ t ) + {b}_{n} sin ( n ϖ t ) ) \qquad ( 1 )$$

Where, a₀ is the DC value of the phase voltage Va, aₙ is a maximum amplitude value of the cosine signal of the phase voltage Va, and bₙ is a maximum amplitude value of the sine signal of the phase voltage Va. The maximum amplitude values aₙ and bₙ can be respectively represented by following equations (2) and (3):

$$\begin{matrix}{a}_{n} = \frac{2}{T} {\int }_{t - T}^{t} Va ( t ) cos ( n ϖ t ) dt & ( 2 ) \\ {b}_{n} = \frac{2}{T} {\int }_{t - T}^{t} Va ( t ) sin ( n ϖ t ) dt & ( 3 )\end{matrix}$$

Where, T is a period of the sine signal and the cosine signal.

The control processor 130 executes a step S230 to calculate a phase amplitude corresponding to each of the phase voltages Va, Vb and Vc according to the maximum amplitude values (for example, aₙ and bₙ) of the cosine signal and the sine signal corresponding to each of the phase voltages Va, Vb and Vc. Where, the phase amplitude M can be calculated according to a following equation (4):

M=\sqrt{aₙ²+bₙ²} (4)

Moreover, the control processor 130 may further calculate a phase angle corresponding to each of the phase voltages Va, Vb and Vc, where the phase angle A is calculated according to a following equation (5):

$${tan}^{- 1} [ \frac{{a}_{n}}{{b}_{n}} ] \qquad ( 5 )$$

Then, in step S240, the control processor 130 determines whether the phase abnormal phenomenon is occurred by determining whether the phase amplitude corresponding to each of the phase voltages Va, Vb and Vc is far greater than 0, and generates a phase abnormal detection result. In an actual operation, taking the phase voltage Va as an example, the control processor 130 may determine whether the phase amplitude M is greater than a predetermined threshold or not, so as to determine whether the phase voltage Va has the phase abnormal phenomenon or not, where the predetermined threshold is a value greater than 0, for example, the threshold can be equal to 1.

Certainly, a magnitude of the threshold can be adjusted by a designer, and the threshold is not limited to 1, where the designer may adjust the threshold according to a driving environment of the bicycle where the motor MT belongs to, which is not limited by the invention.

When the phase abnormal detection result obtained by the control processor 130 indicates that the phase abnormal phenomenon is occurred, the control processor 130 may transmit an interrupt command to the driver 110, and the driver 110 makes the motor MT to stop running according to the interrupt command, so as to prevent the motor MT from being damaged, and guarantee a safety of the user.

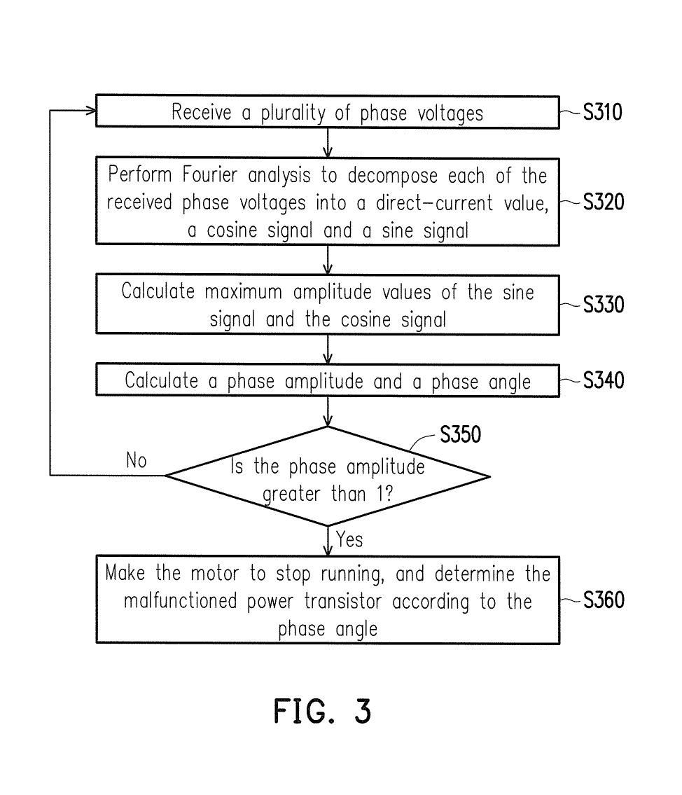

Referring to FIG. 3, FIG. 3 is a flowchart illustrating a driving control method for motor according to an embodiment of the invention. First, in step S310, a plurality of phase voltages for driving the motor is received, and in step S320, a Fourier analysis is performed to decompose each of the received phase voltages into a direct-current value, a cosine signal and a sine signal. Moreover, in step S330, maximum amplitude values of the sine signal and the cosine signal are calculated. Then, a phase amplitude and a phase angle corresponding to each of the phase voltages are calculated according to the maximum amplitude values of the sine signal and the cosine signal (step S340).

In step S350, the phase amplitude obtained in the step S340 is compared to a predetermined value (for example, 1), and if the phase amplitude is greater than 1, it represents that the phase amplitude is far greater than 0, and a step S360 is executed to stop running the motor. Then, a malfunctioned power transistor is determined according to the phase angle obtained in the step S340. Comparatively, if the phase amplitude determined in the step S350 is not greater than 1, the step S310 is re-executed to continually detect the phase voltages.

It should be noted that the driver used for driving the motor is generally constructed by an inverter formed by a plurality of power transistor strings. For example, in the driver, three power transistor strings are adopted to generate three phase voltages, and the three phase voltages are used for driving the motor. The power transistor strings are controlled by a pulse width modulation (PWM) signal to pull up, pull down or float the correspondingly generated phase voltages, so as to present different phase angles on a spatial vector plane. Therefore, by calculating the corresponding phase angle when the phase abnormal phenomenon is occurred, the transistor with malfunction can be learned.

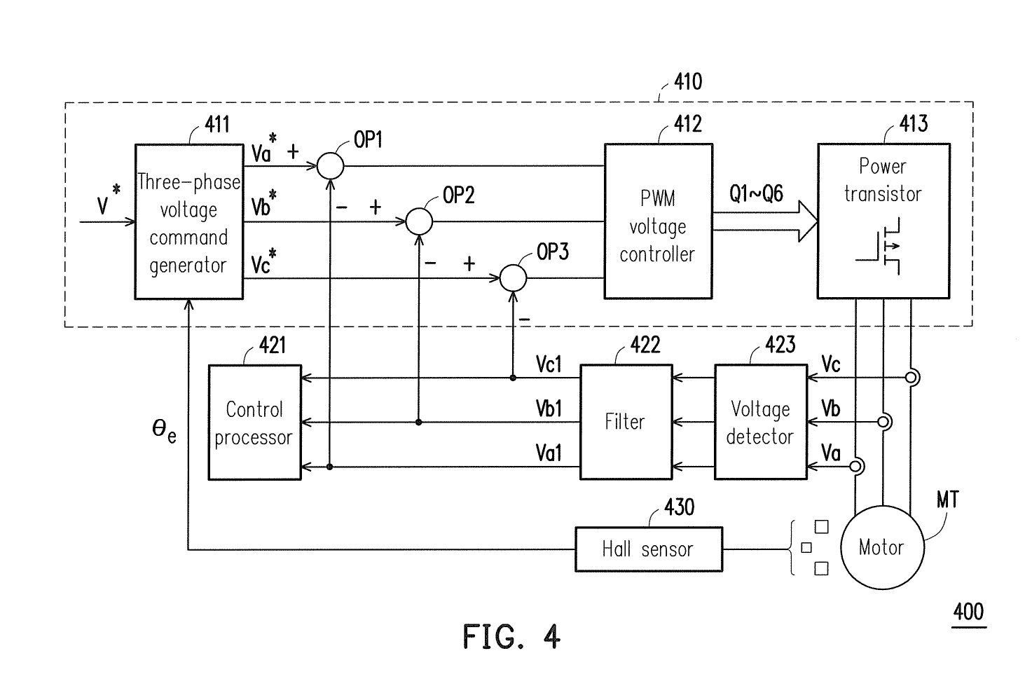

Referring to FIG. 4, FIG. 4 is a schematic diagram of a driving control apparatus for motor according to another embodiment of the invention. The driving control apparatus 400 includes a driver 410, a voltage detector 423, a filter 422, a control processor 421 and a Hall sensor 430. The driver 410 includes a three-phase voltage command generator 411, operators OP1-OP3, a pulse width modulation (PWM) voltage controller 412 and a plurality of power transistors 413. The three-phase voltage command generator 411 receives an electric assisted command V*, and generates command phase voltages Va*, Vb* and Vc* according to the electric assisted command V*. The operators OP1-OP3 respectively receive the command phase voltages Va*, Vb* and Vc*, and respectively subtract the command phase voltages Va*, Vb* and Vc* by filtered phase voltages Va1, Vb1 and Vc1 provided by the filter 422. The PWM voltage controller 412 receives the operation results generated by the operators OP1-OP3, and generates control voltages Q1-Q6 to respectively control the power transistors 413 (the power transistors 413 may include six power transistors). The PWM voltage controller 412 is coupled to the power transistors 413, and the power transistors 413 provide phase voltages Va, Vb and Vc to drive the motor MT.

It should be noted that the embodiment of the invention further includes a Hall sensor 430 coupled to the motor MT, which is used for detecting rotation information θe of the motor MT. The rotation information θe is provided to the three-phase voltage command generator 411 to assist generating the command phase voltages Va*, Vb* and Vc*.

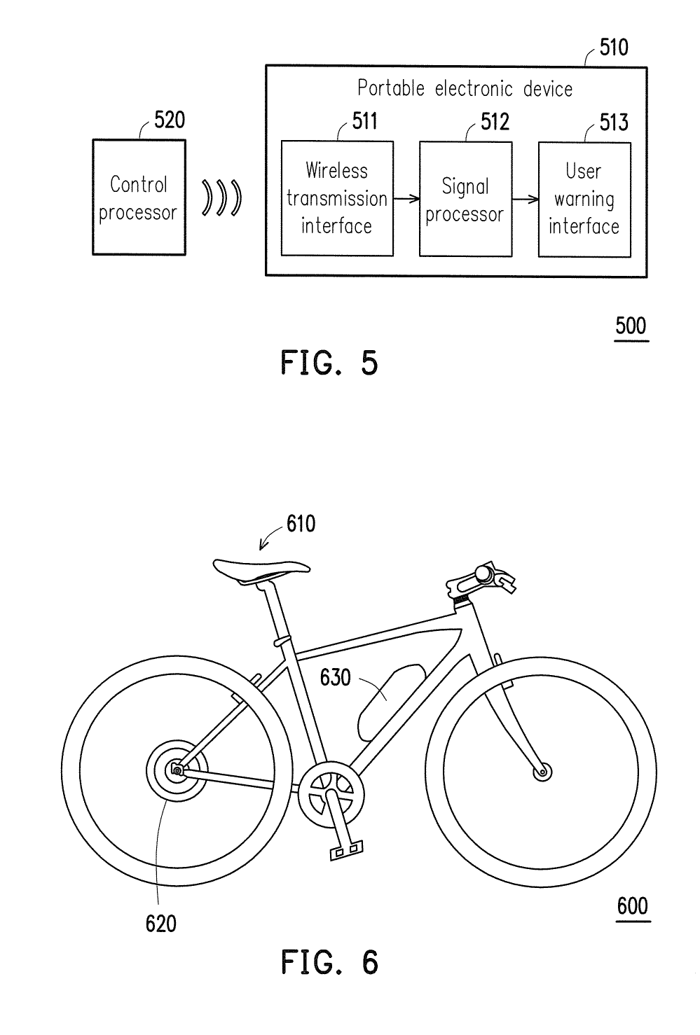

Referring to FIG. 5, FIG. 5 is a partial block diagram of the driving control apparatus according to an embodiment of the invention. In FIG. 5, the driving control apparatus 500 further includes a portable electronic device 510. The portable electronic device 510 is wirelessly coupled to the control processor 520, and performs information transmission operations through a wireless communication method. The portable electronic device 510 includes a wireless transmission interface 511, a signal processor 512 and a user warning interface 513. The wireless transmission interface 511 is wirelessly coupled to the control processor 520, and receives the phase abnormal detection result generated by the control processor 520. The signal processor 512 is coupled to the wireless transmission interface 511, and receives and processes the phase abnormal detection result to generate processing information. The user warning interface 513 is coupled to the signal processor 512, and generates a warning signal according to the processing information. The portable electronic device 510 can be worn on any part of user's body, and the warning signal can be at least of a sound, an image and a vibration, etc. When the phase abnormal phenomenon is occurred, the user is notified with the related abnormal phenomenon and a reason why the motor stops running.

Referring to FIG. 6, FIG. 6 is a schematic diagram of an intelligentialize motive power module according to an embodiment of the invention. The intelligentialize motive power module 600 includes a body 610, a motor 620 and a driving control apparatus 630. The motor 620 can be installed on an axle of a front wheel or a rear wheel of the intelligentialize motive power module, or installed on a bottom bracket, and the driving control apparatus 630 can be fixed at any place on the body 610. The driving control apparatus 630 and the motor 620 can be electrically connected to each other through a wire.

The driving control apparatus 630 of the present embodiment is the same to the driving control apparatus of the aforementioned embodiments, and since operation details of the driving control apparatus have been described in the aforementioned description, details thereof are not repeated.

In summary, in the invention, the phase voltages used for driving the motor are detected, and phase amplitudes of the phase voltages are analysed to determine whether there is a phase abnormal phenomenon, and running of the motor is stopped when the phase abnormal phenomenon is occurred. In this way, the motor is effectively protected from probable damage occurred under an abnormal state, so as to effectively protect user's safety.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A driving control apparatus for motor, comprising:
a driver, generating a plurality of control voltages according to an electric assisted command, and providing a plurality of power transistors for driving the motor according to the control voltages;
a voltage detector, coupled to the power transistors and receiving a plurality of phase voltages provided to the motor by the power transistors; and
a control processor, coupled to the voltage detector, and configured to:
calculate a direct-current value, a cosine signal and a sine signal corresponding to each of the phase voltages;
calculate a phase amplitude corresponding to each of the phase voltages according to the cosine signal and the sine signal corresponding to each of the phase voltages; and
generate a phase abnormal detection result corresponding to each of the phase voltages according to the phase amplitude corresponding to each of the phase voltages.

2. The driving control apparatus for motor as claimed in claim 1, wherein the control processor calculates a maximum amplitude value of the cosine signal and a maximum amplitude value of the sine signal corresponding to each of the phase voltages, and calculates the phase amplitude corresponding to each of the phase voltages according to the maximum amplitude value of the cosine signal and the maximum amplitude value of the sine signal corresponding to each of the phase voltages.

3. The driving control apparatus for motor as claimed in claim 1, wherein the control processor compares the phase amplitude corresponding to each of the phase voltages and a threshold, so as to determine whether each of the phase voltages is abnormal.

4. The driving control apparatus for motor as claimed in claim 3, wherein the control processor transmits an interrupt command to the driver when the phase amplitude of one of the phase voltages is greater than the threshold,
wherein the driver makes the motor to stop running according to the interrupt command.

5. The driving control apparatus for motor as claimed in claim 4, wherein the control processor further calculates a phase angle corresponding to each of the phase voltages according to the cosine signal and the sine signal corresponding to each of the phase voltages.

6. The driving control apparatus for motor as claimed in claim 5, wherein the control processor further determines at least one abnormal phase voltage of the phase voltages with abnormal phase angles, and calculates at least one malfunctioned power transistor in the power transistors according to the phase angle of the at least one abnormal phase voltage.

7. The driving control apparatus for motor as claimed in claim 1, further comprising:
a portable electronic device, wirelessly coupled to the control processor, receiving the phase abnormal detection results, and generating a warning signal.

8. The driving control apparatus for motor as claimed in claim 7, wherein the portable electronic device comprises:
a wireless transmission interface, wirelessly coupled to the control processor, and receiving the phase abnormal detection results;
a signal processor, coupled to the wireless transmission interface, and receiving and processing the phase abnormal detection results to generate processing information; and
an user warning interface, coupled to the signal processor, and generating the warning signal according to the processing information.

9. The driving control apparatus for motor as claimed in claim 1, further comprising:
a filter, coupled between the voltage detector and the control processor, and filtering the phase voltages.

10. An intelligentialize motive power module, comprising:
a motor; and
the driving control apparatus for motor as claimed in claim 1, coupled to the motor, and driving the motor to run.

11. A driving control method for motor, comprising:
generating a plurality of control voltages according to an electric assisted command, and providing a plurality of power transistors for driving the motor according to the control voltages;
calculating a direct-current value, a cosine signal and a sine signal corresponding to each of the phase voltages according to frequency domain analysis;
calculating a phase amplitude corresponding to each of the phase voltages according to the cosine signal and the sine signal corresponding to each of the phase voltages; and
generating a phase abnormal detection result corresponding to each of the phase voltages according to the phase amplitude corresponding to each of the phase voltages.

12. The driving control method for motor as claimed in claim 11, wherein the step of calculating the phase amplitude corresponding to each of the phase voltages according to the cosine signal and the sine signal corresponding to each of the phase voltages comprises:
calculating a maximum amplitude value of the cosine signal and a maximum amplitude value of the sine signal corresponding to each of the phase voltages; and
calculating the phase amplitude corresponding to each of the phase voltages according to the maximum amplitude value of the cosine signal and the maximum amplitude value of the sine signal corresponding to each of the phase voltages.

13. The driving control method for motor as claimed in claim 11, wherein the step of generating the phase abnormal detection result corresponding to each of the phase voltages according to the phase amplitude corresponding to each of the phase voltages comprises:
comparing the phase amplitude corresponding to each of the phase voltages and a threshold, so as to determine whether each of the phase voltages is abnormal.

14. The driving control method for motor as claimed in claim 13, further comprising:
transmitting an interrupt command to the driver when the phase amplitude of one of the phase voltages is greater than the threshold,
wherein the driver makes the motor to stop running according to the interrupt command.

15. The driving control method for motor as claimed in claim 14, further comprising:
calculating a phase angle corresponding to each of the phase voltages according to the cosine signal and the sine signal corresponding to each of the phase voltages.

16. The driving control method for motor as claimed in claim 15, further comprising:
determining at least one abnormal phase voltage of the phase voltages with abnormal phase angles; and
calculating at least one malfunctioned power transistor in the power transistors according to the phase angle of the at least one abnormal phase voltage.

17. The driving control method for motor as claimed in claim 15, further comprising:
transmitting the phase abnormal detection result corresponding to each of the phase voltages to a portable electronic device; and
sending a warning signal by the portable electronic device according to the phase abnormal detection result corresponding to each of the phase voltages.
